(19) United States
(12) Patent Application Publication
(10) Pub. No.: US 2014/0158059 A1
(43) Pub. Date: Jun. 12, 2014

(54) CHICKEN WATER BUCKET

(71) Applicants: SUSAN ANN HASBROUCK, Boise, ID (US); Stuart Drew Watkins, Boise, ID (US)

(72) Inventors: SUSAN ANN HASBROUCK, Boise, ID (US); Stuart Drew Watkins, Boise, ID (US)

(21) Appl. No.: 13/956,015

(22) Filed: Jul. 31, 2013

Related U.S. Application Data
(60) Provisional application No. 61/677,849, filed on Jul. 31, 2012.

(51) Int. Cl. A01K 39/02

(52) U.S. Cl. CPC A01K 39/02
USPC 119/73; 119/72

(57) ABSTRACT

A poultry watering device with a water container with an attached bail, with a centering notch in the center of the bail. The water container has a passage for a heater cord to extend out of said water container. The water container has a removable lid which may be domed, conical, or flat.

### PRIORITY/CROSS-REFERENCE TO RELATED APPLICATIONS

This application claims the benefit of U.S. Provisional Application No. 61/677,849, Jul. 31, 2012, the disclosure of which is incorporated by reference.

### TECHNICAL FIELD

The present technology generally relates to an apparatus for watering animals, and more particularly to backyard poultry waterers.

### BACKGROUND

Backyard chicken farming is rapidly growing in popularity. Most equipment for poultry raising, however, is designed for large-scale or commercial farming operations. Little, if any, poultry farming equipment is designed with an eye toward aesthetics and ease of use for a small-scale chicken farmer. Existing poultry waterers—devices for providing drinking water to poultry—are particularly ill-suited for the average backyard chicken operation. The prior art often uses a trough to deliver water to the poultry. That type of system allows for dirt and chicken waste, especially fecal matter, to contaminant the drinking water. The problem of water contamination is exacerbated when poultry waterers are set at, or close to the ground level, where poultry scratch and expel their waste. It is therefore advantageous to elevate waters above ground level.

An effective means of elevation is hanging the waterer from a rope, chain or cord. The prior art, however, utilizes a bucket with a semi-circular bail (or other hanging mechanism) that causes the waterer to hang or tilt to undesirable angles. This is problematic because it affects the efficiency of the waterer and because it is not aesthetically pleasing—a typical backyard chicken farmer is a woman, who wants her “farm” to appear neat and tidy, so as to complement the rest of a manicured yard area. The prior art sometimes incorporates an additional hanging device, such as a hook, which attaches to the bail, but this is both cumbersome and unattractive.

### SUMMARY OF THE DISCLOSURE

Disclosed here is a poultry waterer comprising a system of water-emitting valves and a lidded vessel, which significantly curtails dirt and fecal contamination. Furthermore, the disclosed poultry waterer is a hanging variety, and it hangs in a stable and balanced position, which is both aesthetically pleasing and increases waterer efficiency. The waterer comprises a bucket-type vessel with a notched bail, a removable lid, and poultry-activated, water-emitting valves on the vessel bottom.

One embodiment of the waterer comprises a generally cylindrical pail, with an easily removable lid, and an attached, generally arched bail, which comprises a number of bends to allow the bail to easily swing about the top of the pail, and which spans the top of the pail. The water container could also be squarish, with four sides. The bail also has a convex bend, disclosed as a centering notch, near the center of the bail's span. This centering notch allows the waterer to hang with its bottom approximately parallel to the ground below. In this way, the water inside the waterer is evenly distributed over the water-emitting valves. The balanced hanging of the waterer also provides for a tidy appearance. There are other chicken waterer's in the prior art which utilize a common white bucket with a bail. A problem with those is that the standard bail has a flat area for a person to grip and lift the bucket. When this kind of bucket is used as a chicken waterer, the flat area on the bail causes the bucket to be unstable, and it can shift from one side or the other, never being stable with an attachment to the middle of the grip. Such instability results in spilled water, and a non-horizontal positioning of the bottom of the bucket. Prior art waterers address this problem by providing devices such as chains or V shaped hooks which attach to either side of a gripping piece on the bail, to a hook above the waterer for hanging the waterer. The present waterer eliminates the need for such an extra device, thus adding to the simplicity and aesthetic appeal of the device, and also reducing the steps needed to make the device and also reducing the costs by reducing the parts and manufacturing steps.

In one embodiment of the waterer, ball-bearing-type poultry watering nipples are used. These poultry nipples are well-known to those skilled in the art.

In one embodiment of the waterer, the lid contains an aperture that allows for certain accessories, including a de-icing mechanism, to be used in the waterer. The aperture can also be used to refill the waterer with water.

Also disclosed is a poultry waterer comprising an enclosed bottle-shaped vessel with a removable lid, a single water-emitting valve, and hook-and-loop fastening system, which allows the waterer to removably attach to another surface, like a chicken brooder box. This single-valve waterer is particularly useful for young poultry, like pullets. This device allows the user to easily change the height of the water-emitting valve, in relation to ground level or the floor of a brooder box, to accommodate the changing height of the poultry as it grows. It also mitigates contamination while being aesthetically pleasing. One embodiment of the single-valve waterer utilizes a ball-bearing-type poultry watering nipple.

### BRIEF DESCRIPTION OF THE DRAWINGS

FIG. 1 is a perspective view of an embodiment of the poultry watering device.

FIG. 2 is a perspective view of the bottom of an embodiment of the poultry watering device.

FIG. 3 is a perspective view of the top of an embodiment of the poultry watering device.

FIG. 4 is a perspective cutaway view of the poultry watering device.

FIG. 5 is a view of a water container with a built in heater.

### DETAILED DESCRIPTION OF THE EXEMPLARY EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

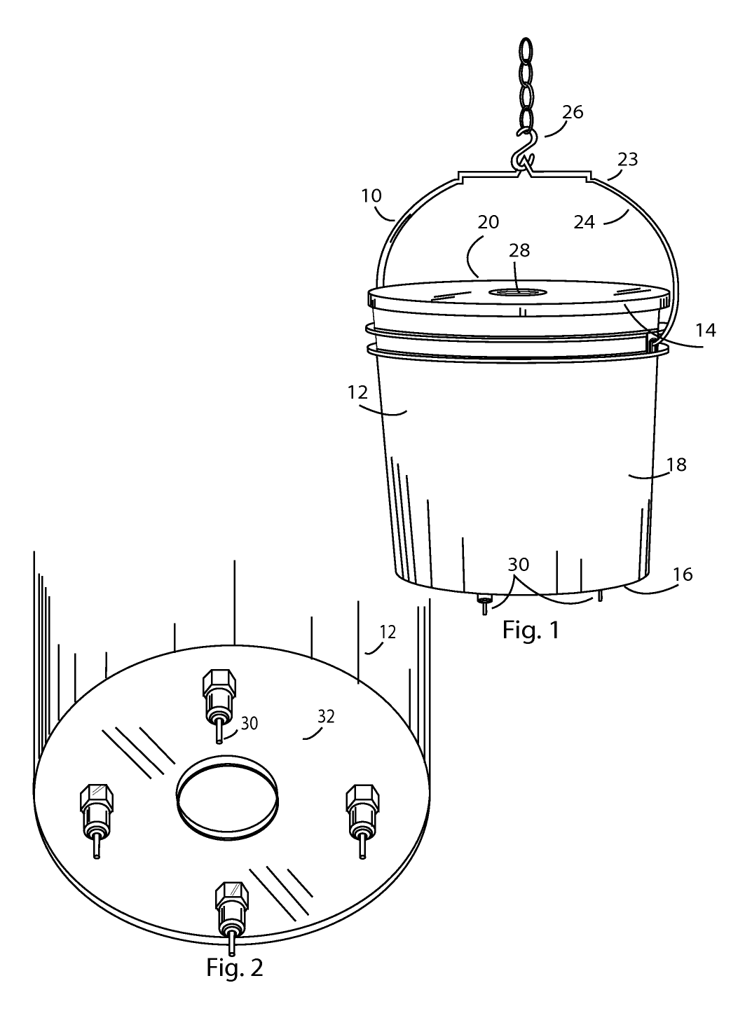

Shown in FIG. 1 is a preferred version of the device. FIG. 1 shows the poultry watering device 10, which is made up of a water container 12, and hanging apparatus 22. In this case the water container 12 is a generally cylindrical plastic container, and it has a top rim 14, a bottom rim 16, and a side wall 18. The water container 12 could also be square or squarish, or be a tapering cylinder. The watering device 10 includes a container lid 20, which in this case is generally flat and round. The hanging apparatus 22 is made up of a wire bail 24, which has at least one convex deviation 26 (or notch) in the center portion of the bail 24. The container lid has a passage 28 which is available for insertion of a heater to keep the water from freezing in cold weather. The device shown in FIG. 1 also includes a number of toggles 30. These are small valves placed on the underside of the waterer, which when pushed sideways by a chicken emit a droplet of water. When they are untouched the valves seal and no water drips out.

FIG. 2 shows an example of the bottom side 32 of the water container 12. This particular version of the poultry watering device includes four water toggles 30, which in use would be pointing at the ground. Chickens of all ages quickly learn to tap on the toggles 30, in order to release a droplet of water. The volume of the water container 12 can be scaled up to allow the poultry owner to have sufficient water for her chickens for many days. This can allow the owner of the chickens to be able to leave the chickens unattended for a week or a weekend.

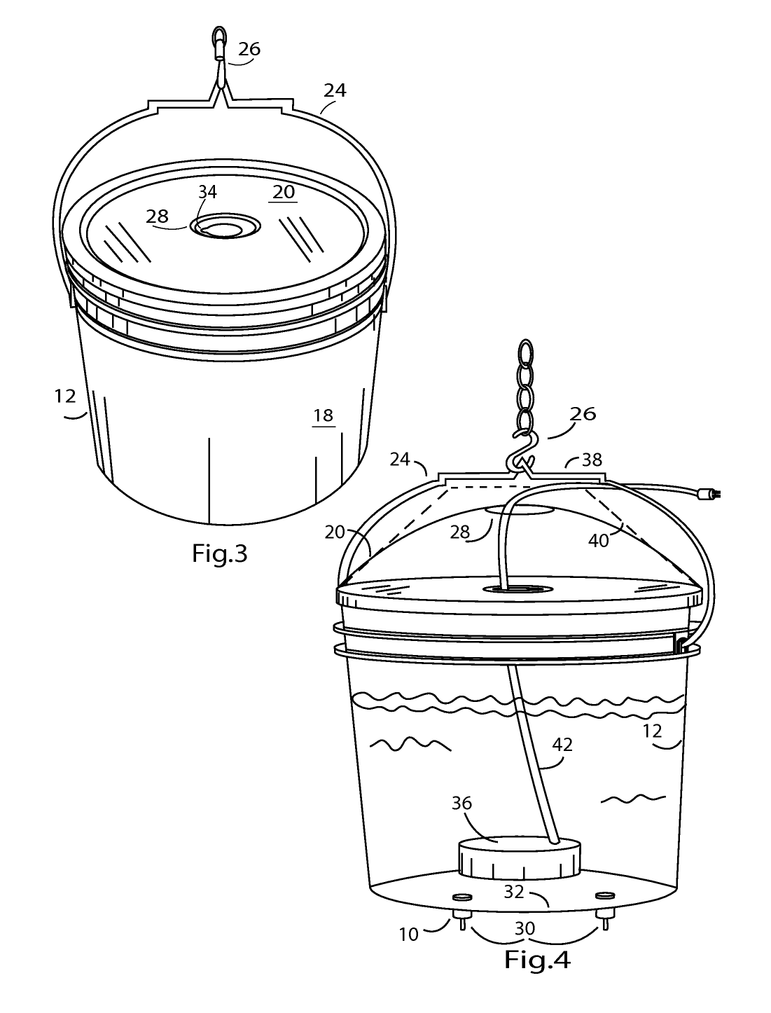

FIG. 3 is another view of the preferred embodiment of the chicken water. This view has all the parts that are shown in the previous drawings, but the toggles 30 are not visible because they are on the bottom. The passage in the container lid 28 is more visible in this view. The passage 28 in the container lid is provided so that a drop in heater may be inserted into the bucket, with the hole being available for the electrical cord of the heater to extend out the top of the container lid. The passage has to be large enough for a three-prong electrical plug in to pass in the hole. Provided on one side of the passage 28 is a cord lock 34. This is a small notch connected to the passage 28. The cord lock 34 is provided so that the electrical cord may be pressed into the cord lock 34, and secured in place so that the cord can't fall back into the inside of the container.

FIG. 4 is a cross-sectional view of another version of the poultry watering device 10, which includes a water container 12, water toggles 30, a bottom side 32, a wire bail 24, and in this version the container lid 20 is comprised of a dome which has a passage 28 in the container lid. The purpose of the dome shape 40 of the container lid is to prevent chickens from sitting on top of the container and fowling the container lid and possibly having some chicken fecal matter enter the water in the bucket. Another preferred shape of the container lid is to have it conical in shape, and a conical shape is shown in dashed lines in FIG. 4 as 38, showing a steady sloping sides and an optional overhang of the top rim of the bucket. This would also prevent chickens from sitting on top of the poultry watering device. This version of the poultry watering devices includes a more deeply convex version of the notch 26, also called the convex deviation.

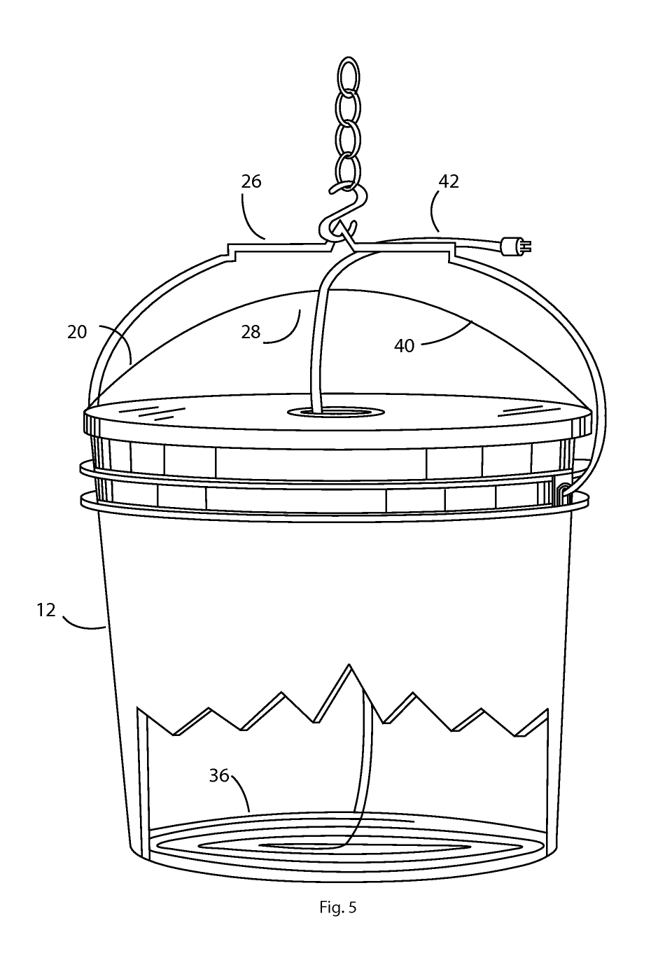

FIG. 5 is a view of the disclosed poultry watering device in a version which includes a built in heater 36, with heating elements built into the plastic water container 12, and with the electrical cord 42 extending outside the water container 12.

While certain exemplary embodiments are shown in the Figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A poultry watering device, comprising:
a water container, having a top rim and a bottom rim and a sidewall extending between said top rim and said bottom rim, and a planar container bottom attached to said container bottom rim;
a removable container lid configured for attachment to said top rim of said water container;
a plurality of water release devices mounted on said container bottom and accessible by poultry from underneath the water container;
a hanging apparatus attached to said water container on opposite sides of said sidewall, said hanging apparatus comprising a bail and further comprising a convex deviation in the center of said wire bail for centering said water container on a hanger.

2. The poultry watering device of claim 1 in which said bail is in a generally semicircular shape.

3. The poultry watering device of claim 1 in which said container lid is generally planar and circular.

4. The poultry watering device of claim 1 in which said water container is generally cylindrical in shape, with a generally circular container lid.

5. The poultry watering device of claim 1 in which said container lid further comprises a passage in a center of said container lid for insertion of a heater.

6. The poultry watering device of claim 1 which further comprises a generally conical covering of said water container.

7. The poultry watering device of claim 1 in which said container lid is generally conical.

8. A poultry watering device, comprising:
a generally cylindrical water container, having a top end and a bottom end and a sidewall extending between said top end and said bottom end, and a planar and circular container bottom attached to said container bottom end;
a generally planar and circular and removable container lid, with said container lid defining a passage for access to the interior of said water container;
a plurality of water release devices mounted on said container bottom and accessible by poultry from underneath the water container;
a hanging apparatus attached to a sidewall of said water container, said hanging apparatus comprising a bail and comprising a convex deviation in the center of said bail for centering said water container on a hanger.

9. The poultry watering device of claim 1 which further comprises a generally conical covering of said water container.

10. The poultry watering device of claim 1 in which said container lid is generally conical.

11. The poultry watering device of claim 1 in which said container lid is generally domed.

12. A poultry watering device, comprising:
a generally cylindrical water container, having a top end and a bottom end and a sidewall extending between said top end and said bottom end, and a planar and circular container bottom attached to said container bottom end;
a removable container lid configured for attachment to said upper rim, with a passage defined in said container lid for access to an interior of said water container; a water heater in said water container, with an electrical cord from said water heater extending through said passage of said container lid;
a plurality of water release devices mounted on said container bottom and accessible by poultry from underneath the water container;
a hanging apparatus attached to a sidewall of said water container, said hanging apparatus comprising a wire bail in a generally semicircular shape and comprising a convex deviation in the center of said wire bail for centering said water container on a hanger.

13. The poultry watering device of claim 1 which further comprises a generally conical covering of said water container.

14. The poultry watering device of claim 1 in which said container lid is generally conical.
